(19) United States
(12) Patent Application Publication
(10) Pub. No.: US 2026/0278905 A1
(43) Pub. Date: Sep. 17, 2026

(54) TEMPORALLY-CONTROLLED MULTI-EVENT DATA SEQUENCE GENERATION

(71) Applicant: Snap Inc., Santa Monica, CA (US)

(72) Inventors: Varnith Uttam Chordia, Jersey City, NJ (US); Yuwei Fang, Redmond, WA (US); Willi Menapace, Los Angeles, CA (US); Aliaksandr Siarohin, Santa Monica, CA (US); Ivan Skorokhodov, Santa Monica, CA (US); Sergey Tulyakov, Santa Monica, CA (US); Ziyi Wu, Los Angeles, CA (US)

(21) Appl. No.: 19/081,739

(22) Filed: Mar. 17, 2025

(51) Int. Cl. G06T 13/80; G06F 40/56; G06N 3/08

(52) U.S. Cl. CPC G06T 13/80; G06N 3/08; G06F 40/56

(57) ABSTRACT

Example systems take as input a text prompt describing events and generate a multi-event video, audio, or data sequence based on the text prompt. Example operations include accessing a sequence of events, the sequence of events comprising time ranges for the events of the sequence of events and text descriptions for the events, accessing a global caption comprising a text description for the sequence of events, and inputting the sequence of events and the global caption simultaneously into a trained neural network to generate a video, audio, or data sequence, where frames of the video, sound of the audio, or data of the data sequence during a time range of the time ranges are in accordance with a corresponding text description of the text descriptions. Additionally, systems are disclosed that train a neural network to generate the multi-event video, audio, or a data sequence from the text prompt.

### TECHNICAL FIELD

Examples of the present disclosure relate generally to generating data sequences, which may be video or audio from text prompts. More particularly, but not by way of limitation, examples of the present disclosure relate to generating videos, audio, or data sequences from multiple event text prompts with event timing control, and global text prompts that describe the multiple events. Additionally, examples relate to training a diffusion transformer neural network to generate videos, audio, or data sequences from text prompts and generating multiple event text prompts from single prompts.

### BACKGROUND

Users increasingly want to generate more complex video, audio, and data sequences from text prompts. However, neural networks that generate videos often are limited in the videos they can generate from text prompts.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 is a diagrammatic representation of a machine in the form of a computer system within which a set of instructions may be executed to cause the machine to perform any one or more of the methodologies discussed herein, according to some examples.

FIG. 6 is a block diagram showing a software architecture within which examples may be implemented.

FIG. 7 illustrates a system for temporally-controlled multi-event video generation, in accordance with some examples.

FIG. 8 illustrates the operation of the video generation components, in accordance with some examples.

FIG. 9 illustrates the operation of training a video generation component, in accordance with some examples.

FIG. 10 illustrates a system for training a video generation component, in accordance with some examples.

FIG. 11 illustrates the operation of training a video generation component, in accordance with some examples.

FIG. 12 illustrates example videos, in accordance with some examples.

FIG. 13 illustrates a system for enhanced prompts, in accordance with some examples.

FIG. 14 illustrates example videos, in accordance with some examples.

FIG. 15 illustrates a method for temporally-controlled multi-event video generation, in accordance with some embodiments.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Often text-to-video neural networks or models generate videos depicting single events from a single text prompt. For example, a text prompt of a “cat drinking milk,” may generate a fifteen second video of a cat drinking milk. However, many of the current text-to-video neural networks have difficulty generating videos for text prompts that include more than one event. For example, a text prompt of “a woman waves hello, gives a thumbs up, and then makes a heart with her hand,” often results in a video being generated that includes only the first event of the text prompt of “a woman waves hello.” The other events are often not included in the video.

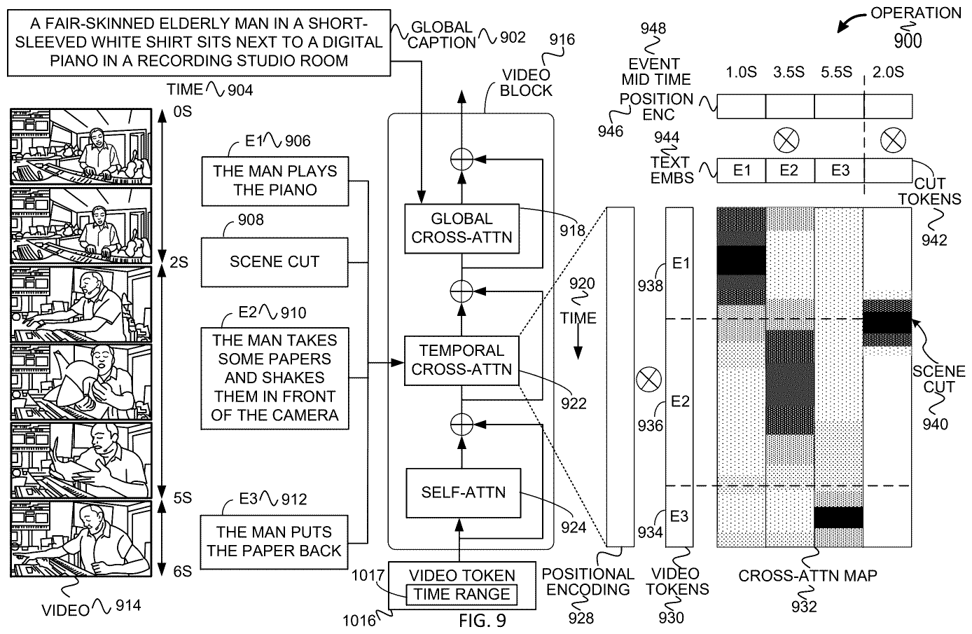

A technical problem is how to generate a video that includes all the events in a multi-event text prompt. The technical problem is addressed by processing the text prompt to include a time range for each event. For example, as illustrated in FIG. 9, “a man plays the piano” (0 S to 1 S), “the man takes some papers and shakes them in front of the camera” (2 S to 5 S), and “the man puts the paper back” (5 S to 6 S). The neural network is trained based on being given time ranges for events of the multi-event text prompt.

Another technical problem is how to maintain consistency with the characters and the scene for a multiple event text prompt. For example, often text-to-video neural networks will switch the person performing the first event of a multi-event text prompt to a new person to perform the second event of the text prompt. Some text-to-video neural networks attempt to solve this technical problem by entering the last frame of the video generated for the previous event as part of the input. But often this results in images of the frames degrading in quality and in changes in the background or scene. Additionally, the videos generated often do not have consistent movement of the people from one event to the next. The technical problem is addressed by generating a relevant global caption such as, continuing with the example in FIG. 9, “a fair-skinned elderly man in a short-sleeved white shirt sits next to a digital piano in a recording studio.” The global caption provides consistency for the multiple events in the multi-event text prompt.

Another technical problem is how to include scene cuts. A scene cut indicates that the generated video does not have to provide intermediate frames for the movement of people between events nor does the scene have to remain consistent. For example, continuing with the example above, the “fair-skinned elderly man” may go from playing the piano to shaking the papers without frames where the “fair-skinned elderly man” stops playing the piano and picks up the papers. The technical problem is addressed by including the scene cuts within the training and are treated as an event with non-moving content and with a start time equal to an end time.

Another technical problem is how to take from users' simple single event prompts or multiple event prompts without time ranges and generate multi-event prompts with time ranges and a global caption. The technical problem is addressed by converting a user's prompt using a large language model (LLM) where the results of the LLM may be processed to ensure a proper format for the trained temporally controlled multi-event video generation neural network (“video generation component”).

Another technical problem is how to train the video generation component to have the following three properties. A first property is that video tokens, from a ground truth input, within a time range of the time range of an event should have higher attention weights for text embedding corresponding to the time range. A second property is that for an event, the attention weights should be highest with video tokens at the midpoint of its time span, and then decrease towards the boundary of the event. A third property is that the video tokens at the transition point between two events should have attention weights the same or similar for the two events.

In some examples, this technical problem is addressed by using a diffusion transformer neural network with an added temporal cross-attention component for video tokens to determine an attention weight to give the event encodings. Additionally, the durations of the events are rescaled to all have a duration. A midpoint of the time range of the event is used to positionally encode or embed the events. Video tokens are positionally encoded by using a timestamp of the video to determine a rotation angle. The video generation component trained as described with the temporal cross-attention component has the three properties described above, in accordance with some examples. Additionally, the same or similar method are applied for audio and data sequences.

### Networked Computing Environment

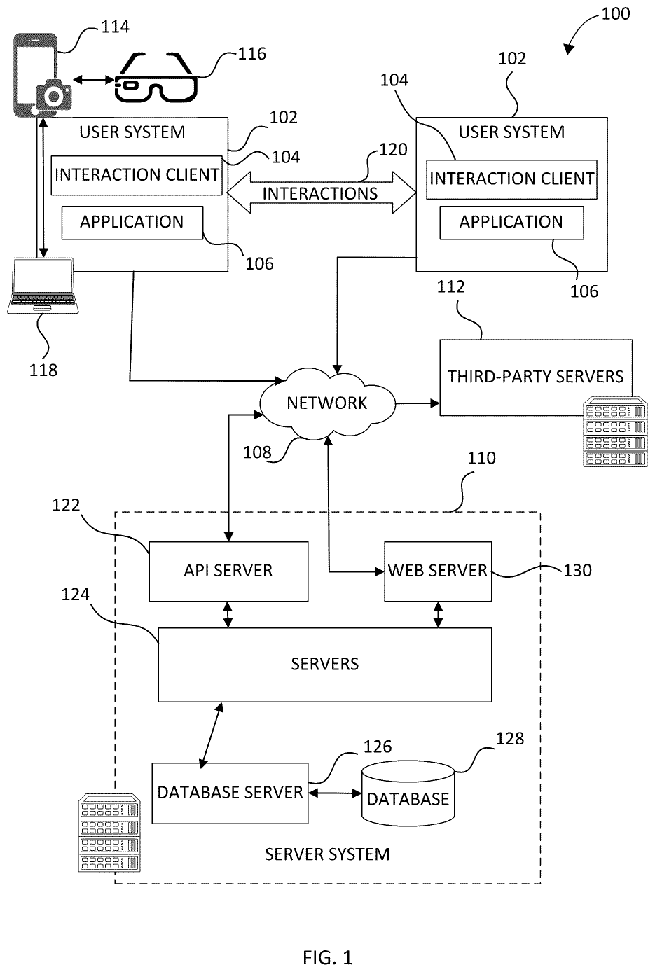

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

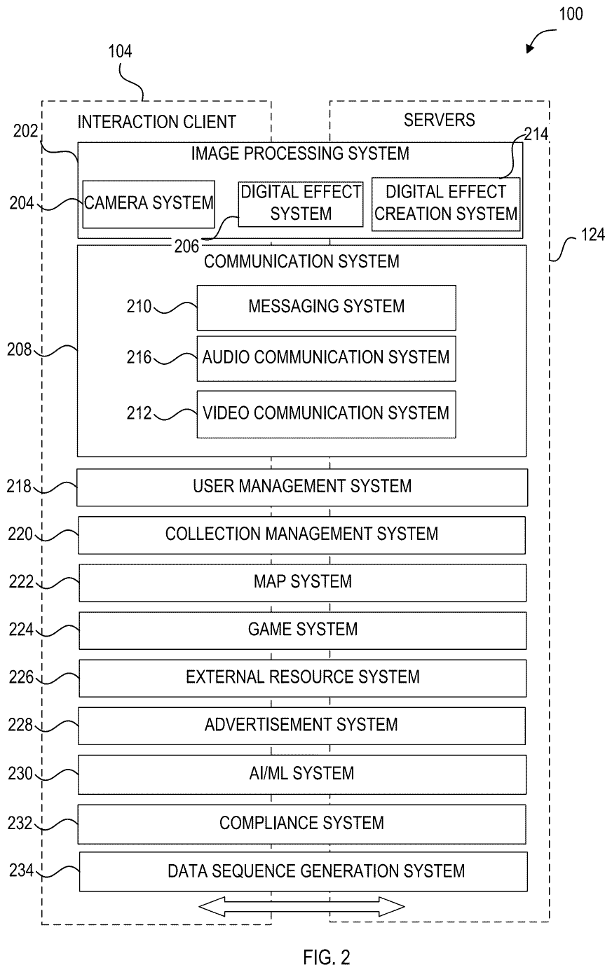

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below. An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from instructions 502 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 frame work.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

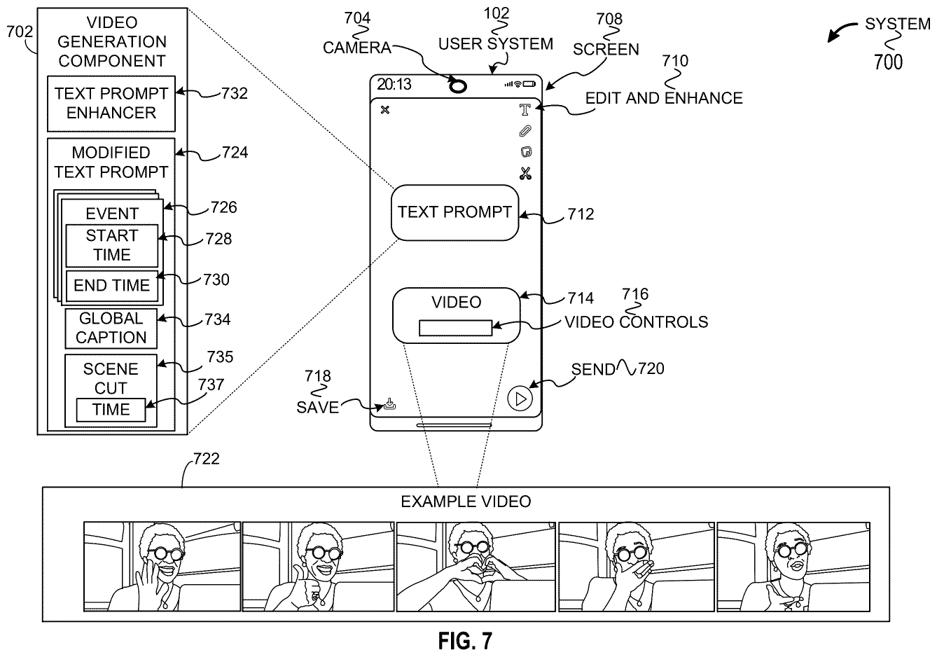

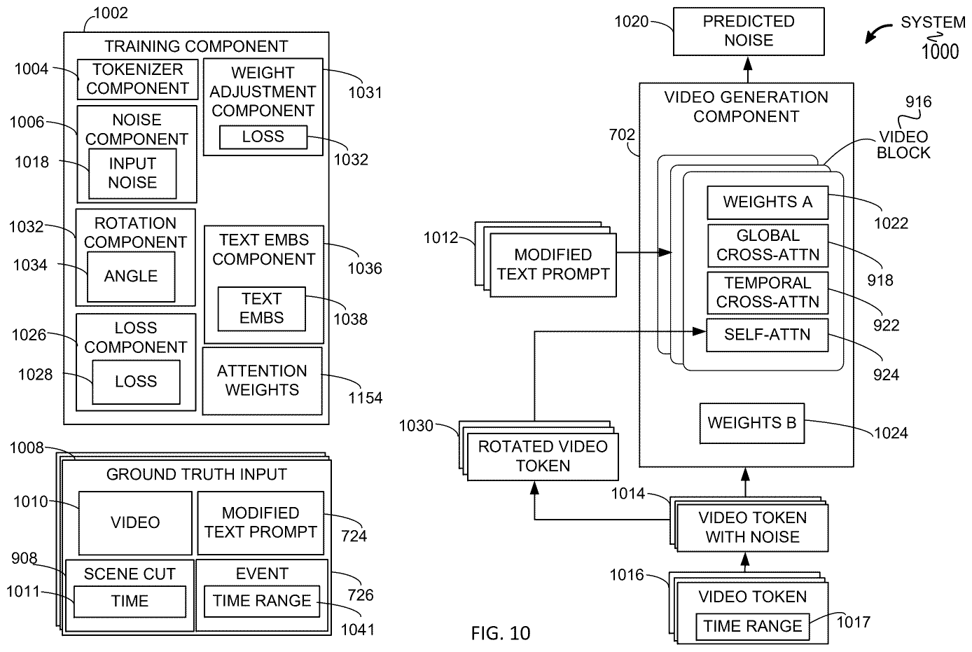

The data sequence generation system 234, referring to FIGS. 7 and 10, provides functions associated with the video generation component 702 and the training component 1002. Additionally, the data sequence generation system 234 may act as an intermediary for sending data between the user system 102 and the server system 110. The data sequence generation system 234 additionally provides support for sharing videos, codes, and access to social media accounts.

### Data Architecture

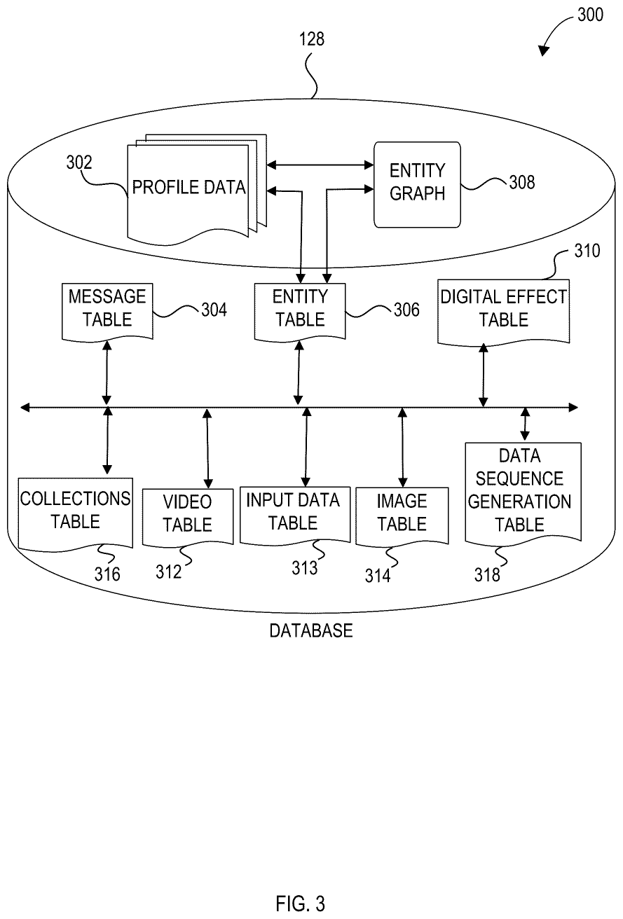

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video. An input data table 313 stores data regarding input data.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include data sequence generation table 318. The data sequence generation table 318 includes, referring to FIGS. 7 and 10, weights A 1022, weights B 1024, an application including the video generation component 702, the training component 1002, and so forth.

### Data Communications Architecture

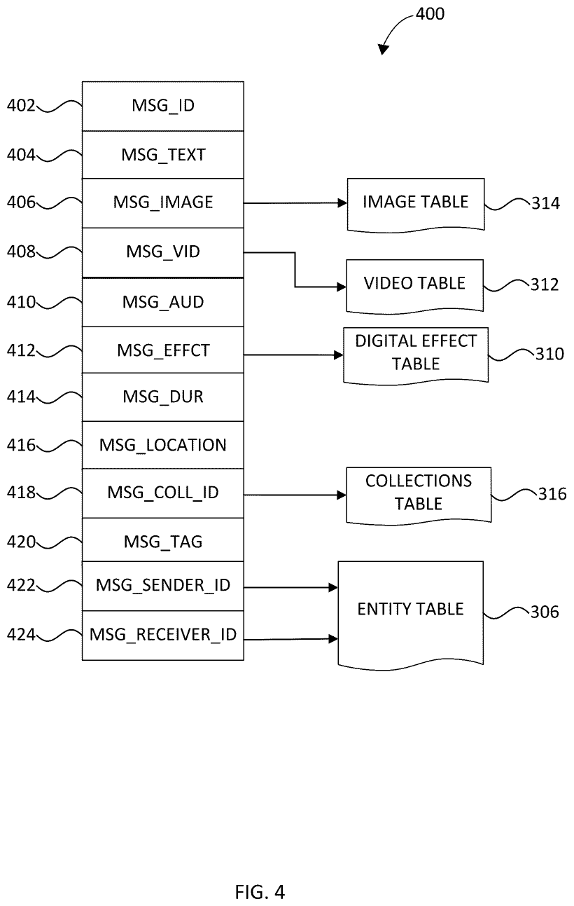

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier (msg_id 402): a unique identifier that identifies the message 400.
Message text payload msg_text 404): text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter (msg_dur 414): parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within an image table 314, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

System with Head-Wearable Apparatus

### Machine Architecture

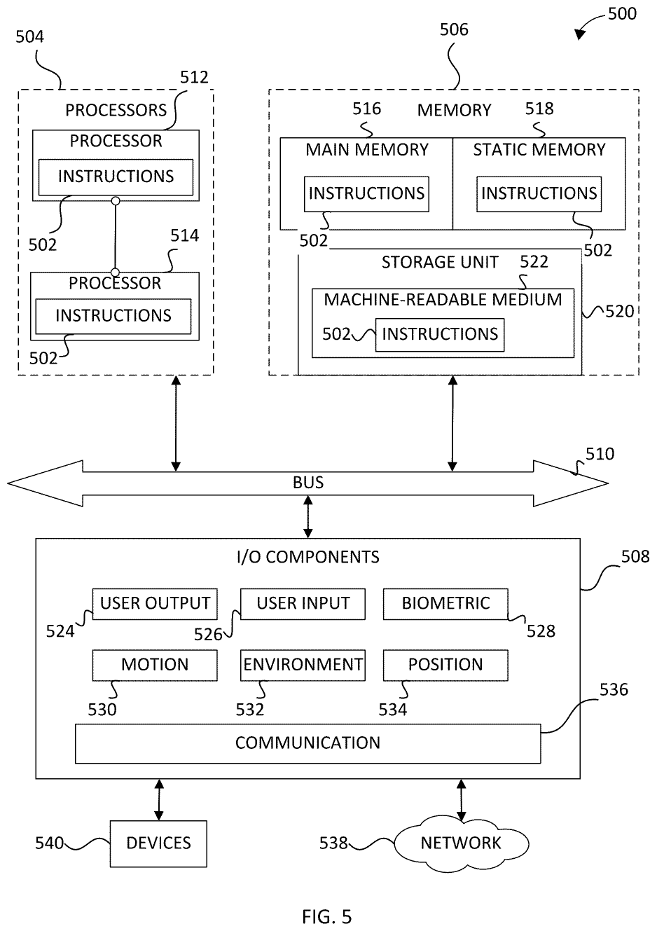

FIG. 5 is a diagrammatic representation of the machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the methods described herein. The instructions 502 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, may comprise the user system 102 or any one of multiple server devices forming part of the server system 110. In some examples, the machine 500 may also comprise both client and server systems, with certain operations of a particular method or algorithm being performed on the server-side and with certain operations of the method or algorithm being performed on the client-side.

The machine 500 may include processors 504, memory 506, and input/output I/O components 508, which may be configured to communicate with each other via a bus 510. The processors 504 include processor 512 and processor 514.

The memory 506 includes a main memory 516, a static memory 518, and a storage unit 520, both accessible to the processors 504 via the bus 510. The main memory 506, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The I/O component 508 can include biometric 528 inputs/outputs and position 534 inputs/outputs. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a USB).

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

### Software Architecture

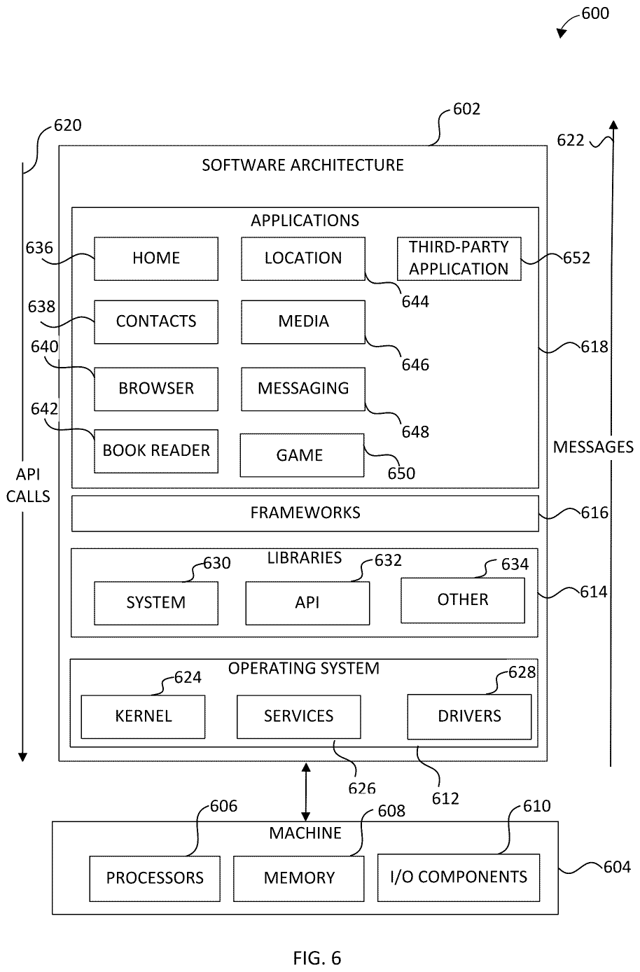

FIG. 6 is a block diagram 600 illustrating a software architecture 602, which can be installed on any one or more of the devices described herein. The software architecture 602 is supported by hardware such as a machine 604 that includes processors 606, memory 608, and I/O components 610. In this example, the software architecture 602 can be conceptualized as a stack of layers, where each layer provides a particular functionality. The software architecture 602 includes layers such as an operating system 612, libraries 614, frameworks 616, and applications 618. Operationally, the applications 618 invoke API calls 620 through the software stack and receive messages 622 in response to the API calls 620.

The operating system 612 manages hardware resources and provides common services. The operating system 612 includes, for example, a kernel 624, services 626, and drivers 628. The kernel 624 acts as an abstraction layer between the hardware and the other software layers. For example, the kernel 624 provides memory management, processor management (e.g., scheduling), component management, networking, and security settings, among other functionalities. The services 626 can provide other common services for the other software layers. The drivers 628 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 614 provide a common low-level infrastructure used by the applications 618. The libraries 614 can include system libraries 630 (e.g., C standard library) that provide functions such as memory allocation functions, string manipulation functions, mathematical functions, and the like. In addition, the libraries 614 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 614 can also include a wide variety of other libraries 634 to provide many other APIs to the applications 618.

The frameworks 616 provide a common high-level infrastructure that is used by the applications 618. For example, the frameworks 616 provide various graphical user interface (GUI) functions, high-level resource management, and high-level location services. The frameworks 616 can provide a broad spectrum of other APIs that can be used by the applications 618, some of which may be specific to a particular operating system or platform.

In an example, the applications 618 may include a home application 636, a contacts application 638, a browser application 640, a book reader application 642, a location application 644, a media application 646, a messaging application 648, a game application 650, and a broad assortment of other applications such as a third-party application 652. The applications 618 are programs that execute functions defined in the programs. Various programming languages can be employed to create one or more of the applications 618, structured in a variety of manners, such as object-oriented programming languages (e.g., Objective-C, Java, or C++) or procedural programming languages (e.g., C or assembly language). In a specific example, the third-party application 652 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 652 can invoke the API calls 620 provided by the operating system 612 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Temporally-Controlled Multi-Event Video Generation

FIG. 7 illustrates a system 700 for temporally-controlled multi-event video generation, in accordance with some examples. Illustrated in FIG. 7 is a user system 102 with a screen 708 and a camera 704. The user system 102 may be a mobile device 114, head-wearable apparatus 116, or another device. Displayed on the screen are user interface items including edit and enhance 710, save 718, and send 720. The user interface items are used to invoke operations that can be performed on the video 714 or other content items. For example, the edit and enhance 710 operation can edit or add effects to the video 714. The save 718 can save the video 714 to, for example, the messaging system 210 associated with an account and a user of the messaging system 210. The send 720 operation can send the video such as to another user of the messaging system 210 in a message.

The video generation component 702 takes a text prompt 712 and generates a video 714 based on the text prompt 712. The video controls 716 provide operations for editing or playing the video 714. The video generation component 702 is a temporally-controlled multi-event video generation component, in accordance with some examples. The video generation component 702 resides on the user system 102, the server system 110, and/or one or more other computing devices. The functionality of the video generation component 702 may be split among multiple computing devices such as between the video generation system 234 of FIG. 2 and video generation component 702.

The text prompt enhancer 732 generates a modified text prompt 724 from the text prompt 712. The text prompt 712 can be entered by a user of the user system 102. The text prompt 712 can be a sequence of events 726 each having a start time 728 and end time 730. An example text prompt 712 is “an old lady waves her right hand,” then “makes a thumbs-up gesture,” then “makes a heart gesture,” then “gives a blow kiss.” The text prompt enhancer 732 can add a start time 728 and an end time 730 for each event 726 of the modified text prompt 724 and can split multi-event text prompts 712 into multiple events 726 each with a start time 728 and an end time 730. The text prompt enhancer 732 additionally can generate a global caption 734 that depicts the content such as a background and subject appearance. The text prompt enhancer 732 can add scene cuts 735, which indicate that it is not necessary for the generated video 714 to be continuous, after the scene cut 735 at time 737, with the video 714 before the cut 735. A user or another component can generate or enter text prompts 712 similar to or the same as the text prompt enhancer 732. The video generation component 702 generates the video 714 from the modified text prompt 724, which is fed into the video generation component 702 all at once. In the example video 722 there are four events 726, “waves her right hand,” “makes a thumps-up gesture,” “makes a heart gesture,” and “blows a kiss,” where each have been assigned a start time 728 and an end time 730. The global caption 734 may be “a middle-aged woman in a bright room.” The example video 722 has a duration of approximately one minute but the video 714 can be of a different duration such as ten seconds to ten minutes.

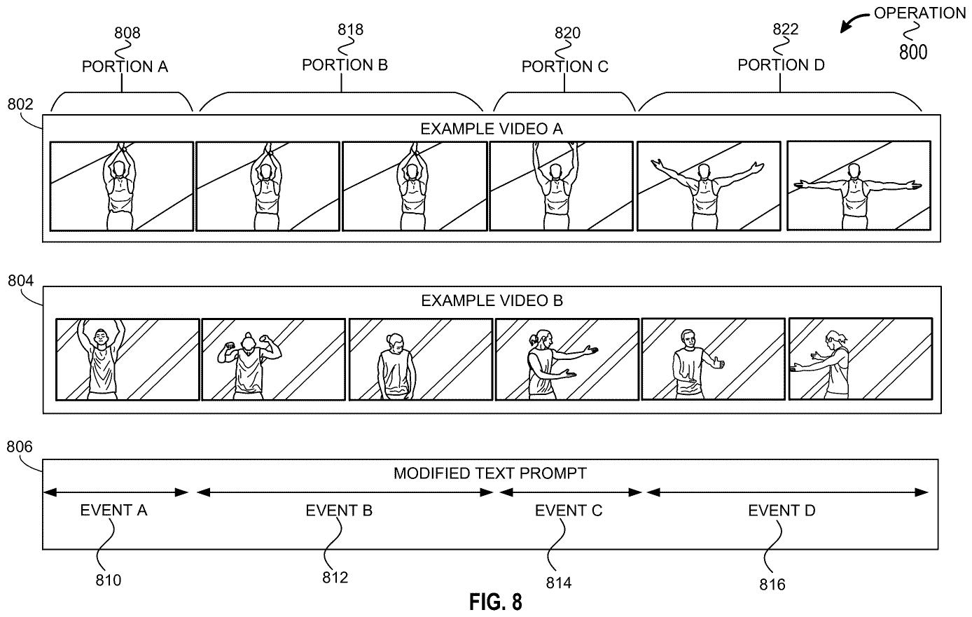

FIG. 8 illustrates the operation 800 of the video generation components, in accordance with some examples. The results of entering, referring to FIG. 7, a text prompt 712 into two examples of the video generation component 702 are illustrated as example video A 802 and example video B 804. The text prompt 712 used to generate example video A 802 is “a man lifts his head and arms up,” then “lowers them down,” then “moves his head and arms to his left,” then “moves them to his right”. A modified text prompt 806 is used to generate example video B 804.

Example video A 802 and example video B 804 are divided into portions for discussion purposes. The portions are portion A 808 corresponding to event A 810 (“a man lifts his head and arms up”, portion B 818 corresponding to event B 812 (“lowers them down”), portion C 820 corresponding to event C 814 (“moves his head and arms to his left”), and portion D 822 corresponding to event D 816 (“moves them to his right”).

The example of the video generation component 702 that generated example video A 802 from the text prompt 712 does not generate the start time 728 and end time 730 for each of the events. The text prompt 712 is concatenated and fed into the video generation component 702 and the video generation component 702 has difficulty at event B 812 (“lowers them down”). In some examples, the video generation component 702 is configured to use autoregression where the results of event A 810 (“a man lifts his head and arms up”) are fed back into the video generation component 702 with event B 812 (“lowers them down”). However, this generates an example video with limited motion and errors from previous frames are magnified.

In the example of the video generation component 702 that generated example video B 804, the text prompt 712 is modified by the text prompt enhancer 732 to generate the modified text prompt 806 with the start time 728, end time 730, and global caption 734. The global caption 734 is a “young muscular man against a striped wall.”

The modified text prompt 724 is fed into the video generation component 702. One frame is used of example video B 804 to illustrate event A 810, two frames of example video B 804 are used to illustrate event B 812, one frame of example video B is used to illustrate event C 814, and two frames of example video B 804 are used to illustrate event D 816.

The video generation component 702 generates videos that are a closer match to the text prompt 712 when the modified text prompt 724 is fed into the video generation component 702 compared with videos generated using only the text prompt 724. The video generation component 702 used to generate example video A 802 has a different structure and was trained differently than the video generation component 702 used to generate example video B 804.

FIG. 9 illustrates the operation 900 of training a video generation component, in accordance with some examples. FIG. 10 illustrates a system 1000 for training a video generation component, in accordance with some examples. FIGS. 9 and 10 are described in conjunction with one another. The training component 1002 of FIG. 10 trains the video generation component 702, the audio generation component 750, and the sequence of data generation component 752. FIG. 9 illustrates the operation 900 of the training.

The video block 916 is a component of the video generation component 702 of FIGS. 7 and 10. The video 914, which is processed to determine video tokens 1016, is associated with E1 906, scene cut 908, E2 910, and E3 912. The events E1 906, E2 910, E3 912, and scene cut 908 are bound to specific ranges of time 904. In this example, E1 906, “The man plays the piano”, is from 0 S to 2 S and has two example frames from the video 914. E2 910, “The man takes some papers and shakes them in front of the camera”, is from 2 S to 5 S and has three example frames. E3 912, “The man puts the paper back”, is from 5 S to 6 S and has one example frame. There is one scene cut 908 at 2 S. There is a global caption 902, “a fair skinned elderly man in a short-sleeved white shirt sits next to a digital piano in a recording studio room.” The global caption 902 assists in maintaining consistency throughout the generated video 914 and is input to or fed into at least the global cross attention (global cross attn 918) component. Video tokens 1016 are input to the self-attention (self-attn 924) component. The events, global caption 902, and video tokens 1016 can receive further processing before being input to the video block 916 as discussed herein.

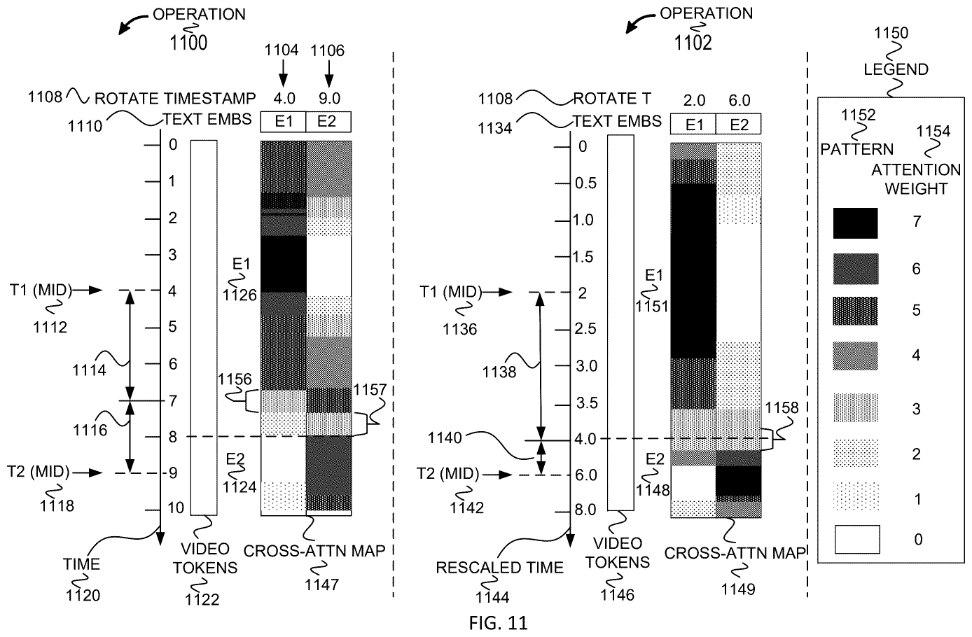

The temporal cross-attn 922 component takes as input the positional encoding 928 of the video tokens 1016 with a cross product of the video tokens 930. The cross-attn map 932 illustrates weights or attention scores or values that the temporal cross-attn 922 component determines for the video tokens 930 in relation to the text embedding (text embs 944). FIG. 11 includes a legend 1150 for the different patterns 1152 where darker patterns 1152 have a higher attention weight 1154. The attention weight 1154 indicates the relative values of the actual attention weights 1154. Along the top of the cross-attn map 932 is the event mid time 948 of the position encoding (position enc 946), which are 1.0X, 3.5 S, 5.5 S, and 2.0 S for the cut tokens 942. The four columns are for text embs 944, E1, E2, E3, and the cut tokens.

The video tokens 930 illustrate the video tokens 1016 with their time spans within the video 914 and illustrate how the positional encoding 928 is used to encode the positions of the video tokens 930 within the video 914 for the temporal cross-attn 922 component. The weights 1154 illustrate that the positional encoding 928 enables the temporal cross-attn 922 component to focus attention or weights 1154 for the events during the proper time 920.

The first column, E1, is for weight 1154 determined for the video tokens 930 that have time values within 0 S to 2 S. The second column, E2, is for weights 1154 determined for the video tokens 930 between 2 S and 5 S. The third column, E3, is for weights 1154 determined for the video tokens 930 between 5 S and 6 S. The weights 1154 indicate that higher weights or attention weights 1154 are given to text embs 944 that fall within the time range of the video tokens 930 with higher values near the event mid time 948. The temporal cross-attn 922 component determines high weights 1154 for the scene cut 940, the fourth column, for text embs 944 that are right before and right after the scene cut 940 time of 2 S.

The training component 1002 trains the video generation component 702, the audio generation component 750, and the sequence of data generation component 752. Examples are provided for training the video generation component 702 but training the audio generation component 750 or sequence of data generation component 752 are similar. For the audio generation component 750, the ground truth input 1008 is for audio sequences 751, and the other components of the training component 1002 operate on audio sequences 751. For the sequence of data generation component 752, the ground truth input 1008 is for data sequences 753, and the other components of the training component 1002 operate on data sequences 753.

The training component 1002 trains the video generation component 702, referring to FIGS. 7 and 10, to take as input a sequence, N^{e}, of temporally localized text prompts,

$${\{ ( {c}_{n} , {t}_{n}^{start} , {t}_{n}^{end} ) \}}_{n = 1}^{N \hat{} e} ,$$

and N^{cut} cut timestamps,

$${\{ {t}_{n}^{cut} \}}_{n = 1}^{N \hat{} cut} .$$

For example, N^{e} is a sequence of events 726, c, each having a start time 728,

$${t}_{n}^{start} ,$$

and an end time 730,

$${t}_{n}^{end}$$

for the nth event 726, where e is the number of events 726 and c is the text of the event 726. Additionally, N^{cut} cut timestamps,

$${\{ {t}_{n}^{cut} \}}_{n = 1}^{N \hat{} cut} ,$$

is one or more scene cuts 735 at time 737, where cut is the number of scene cuts 735 and

$${t}_{n}^{cut}$$

is the time 737 for the nth scene cut 735. The trained video generation component 702 outputs a video 714.

The training component 1002 trains the video generation component 702 to output a video containing all the events 726 in accordance with the text of the event, cₐ, and in accordance with the time range of the event

$$( {t}_{n}^{start} , {t}_{n}^{end} ) .$$

For example, the video 714 should have segments for each of the events 726 in accordance with the text of the event 726 and in accordance with the corresponding start time 728 and end time 730 of the event 726.

Additionally, the video 714 is to include scene cuts 735 at the times 737 of the scene cuts 735 where the event 726 before the scene cut 735 does not have to have intermediate steps to the event 726 after the scene cut 735. For example, in FIG. 9, the video 914 portion before the scene cut 908 has the man's hands on the piano and immediately after the scene cut 908 the man's hands are on papers. In the video 914 there are no or few intermediate frames where the man's hands move from the piano to the papers.

The training component 1002 trains the video generation component 702 using a ground truth input 1008. The ground truth input 1008 includes pairs of video 1010 and modified text prompts 724. The modified text prompts 1012 are the same or similar as modified text prompt 724 that describe the video 1010. And the video 1010 is the same or similar as video 714.

The tokenizer component 1004 of the training component 1002 takes a video 1010 from the ground truth input 1008 and encodes it into a video token 1016, z. The video 1010 includes multiple portions corresponding to the events 726 of the modified text prompt 724. The noise component 1006 adds input noise 1018, ∈ₜ, to the video token 1016 to generate the video token with noise, zₜ, where t is the iteration of training where the amount of input noise 1018 is progressively increased. The noise component 1006 generates the input noise 1018 using Gaussian noise and increases the noise with each iteration, t, of training for a ground truth input 1008, in accordance with some examples. The video token with noise 1014 and the corresponding modified text prompt 724 from the ground truth input 1008 are input into the video generation component 702, which generates the predicted noise 1020.

The loss component 1026 determines a loss 1028, [symbol] between the predicted noise 1020 and the input noise 1018 in accordance with Equation (1): [symbol] =|vₜ−u_{θ}(zₜ, t, y)∥², where vₜ=∈ₜ−z. The u_{θ} represents the operation of inputting the video 1010 and determining the predicted noise 1020. The y is the conditioning signal, which here is modified text prompt 724. The t is the iteration of the training. The weight adjustment component 1031 adjusts the weights B 1024 and weight A 1022 based on the loss 1028 using a method such as back propagation. After the training component 1002 has trained the video generation component 702 to be able to predict the input noise 1018, the video generation component 702 can then be used to generate the video 714. This type of training can be termed diffusion.

The video block 916, referring back to FIG. 9, includes a self-attention (self-attn 924) component for the video tokens 930 and a temporal cross attention (temporal cross-attn 922) component for fusing the video tokens. The video block 916 can include a multilayer perception (MLP) neural network. Each of these elements include weights A 1022 or weights B 1024 that are adjusted by the weight adjustment component 1031 and then used by the trained video generation component 702.

The rotation component 1032 generates the rotated video token 1030 from the video token with noise 1014. In some examples, the noise is added after the video token 1016 is rotated. The rotation component 1032 takes a sequence of N video tokens with noise 1014, x,

$${\{ {x}_{n} \}}_{n = 1}^{N}$$

and determines an angle 1034, θₙ, for each video token xₙ using its position n, and rotates xₙ with θₙ to generate the rotated video token 1030, \tilde{x}ₙ. The angle 1034, On, is determined based on the position n of the video token with noise 1014, xₙ, and can be determined using equation (2): θₙ=nθ_{base}, \tilde{x}ₙ=R(xₙ, n)=xₙe^{iθ}^{ₙ}, where R( ) indicates the application of the rotation component 1032, i is the square root of negative 1, and θ_{base} is a pre-defined base angle or a randomly selected angle. The θₙ can be a vector or list of angles. The video token with noise 1014 of E1 906 has n=1, of E2 910 has n=2, and of E3 912 has n=3. The rotated video tokens 1030 are all input into video block 916 at once so the rotation provides the positional information. The rotated video tokens 1030 can be input into multiple portions of the video block 916 such as into the self-attn 924 component and other components.

In some examples, the video token with noise 1014 is not rotated but another input to the self-attn 924 component is rotated. The angle 1034 of a video token with noise 1014, xₙ, and the angle 1034 of a video with noise 1014, xₘ, are close to one another, if n and m are close to one another. This encodes the positional information and enables the self-attn 924 component to learn the positional information when all the rotated video tokens 1030 of a video 1010 are input into the self-attn 924 component at the same time. In some examples, the rotation component 1032 generates the rotated video token 1030 from the video token with noise 1014 based on a positional embedding using the timestamp 1108.

The self-attn 924 component determines video tokens with noise 1014, xₙ, which are nearby one another to have a higher self-attention weight, A_{n,m}, where n is the nth video token with noise 1014 and m is the mth video token with noise 1014.

The self-attn 924 component determines A_{n,m} in accordance with Equation (3):

$${A}_{n , m} = Re [ 〈 {\tilde{x}}_{n} , {\tilde{x}}_{m} 〉 ] = Re [ 〈 {x}_{n} , {x}_{m} 〉 {e}^{i ( n - m ) {θ}_{b a s e}} ] = Re [ R ( 〈 {x}_{n} , {x}_{m} 〉 , n - m ) ] ( n - m ) {θ}_{b a s e} ∈ [ - \frac{π}{2} , \frac{π}{2} ] ,$$

A_{n,m} decreases monotonically with |n−m| when (n−m)θ_{base}∈[−π/2, π/2]. In some examples, the video tokens 1016 have a lower resolution. In some examples, there is a different rotation for the temporal cross-attn 922 component compared with the rotation for the global cross attn 918 component.

As illustrated in FIG. 9, the temporal cross-attn 922 component provides temporal conditioning between the text embs 944 and the video token 1016. The text embs 944 are determined as follows. The events such as E1 906, E2 910, and E3 912 are termed e and

$${e}_{n}^{c} ∈ {ℝ}^{L \hat{} c \times D \hat{} c} ,$$

where cₙ is the text prompt for the nth event, L\hat{ }c is the text length, and D\hat{ }c is the text embedding dimension.

The text embs component 1036 of FIG. 10 determines positional encoding for each event 726,

$${e}_{n}^{c} ,$$

to indicate its time span

$$[ {t}_{n}^{start} , {t}_{n}^{end} ]$$

and concatenates them along the sequence dimension to generate the text embs 1038,

$${e}_{n}^{∼ c} .$$

The temporal cross-attn 922 component can then determine the cross-attention values, \hat{z}, in accordance with Equation (4):

$$z = X . Attn ( z , Concat ( {\tilde{e}}_{1}^{c} , {\tilde{e}}_{2}^{c} , … , {\tilde{e}}_{N \hat{} e}^{c} ] ) ) , where {e}_{n}^{∼ c} = Pos . Enc ( {e}_{n}^{c} , {t}_{n}^{start} , {t}_{n}^{end} ) ,$$

X.attn( ) indicates an operation of the temporal cross-attn 922 component to determine the cross attention values as illustrated by the cross-attn map 932, and pos.enc ( ) indicates an operation of the text embs component 1036.

In some examples, the temporal cross-attn 922 component determines the text embs 1038 or positional encoding of the nth event,

$${e}_{n}^{c} ,$$

by hard masking. In hard masking,

$${e}_{n}^{c}$$

is only used to determine X.attn( ) if a time range 1017 of the video token 1016 is within the time range

$$( {t}_{n}^{start} , {t}_{n}^{end} )$$

of the event

$${e}_{n}^{c} .$$

However, the video 714 generated may not be as smooth because the video tokens 1016 may be processed more completely if the video tokens 1016 are processed with events that are near the time range 1017 of the video token 1016 and not just within the time range 1017 of the video token 1016.

In some examples, the temporal cross-attn 922 component determines the attention weights 1154 and the results can be evaluated based on three key properties. A first property is that video tokens 1016 within a time range 1017 of the time range,

$${t}_{n}^{start} , {t}_{n}^{end} ,$$

of an event,

$${e}_{n}^{c} ,$$

should have higher attention weights 1154 for text embedding, text embs 944, corresponding to the time range,

$${t}_{n}^{start} , {t}_{n}^{end} .$$

For example, referring to the cross-attn map 932, for the text embs 944 E1, the video tokens 930 having a time range 1017 within the time range of E1 938 have higher attention weights 1154 as indicated by the denser patterns 1152 in the time range of E1 938 compared to the attention weights 1154 within the time range of E2 936 or the time range of E3 934.

A second property is that for an event,

$${e}_{n}^{c} ,$$

the attention weights 1154 should be highest with video tokens 1016 at the midpoint of its time span, and then decrease towards the boundary of the event. For example, referring to the cross-attn map 932, for the text embs 944 E1, the video tokens 930 at the midpoint of E1 938 have the highest attention weights 1154 within the time range,

$${t}_{n}^{start} , {t}_{n}^{end} ,$$

of E1 938. Additionally, the attention weights 1154 decrease as the video tokens 930 approach the borders of the time range of E1 938 such as at the scene cut 940, the attention weights 1154 are represented with a pattern 1152 indicating an attention weight 1154 of 3 compared with pattern 1152 at the center of the time range of E1 938 where the pattern 1152 indicates an attention weight 1154 of 7.

A third property is that the video tokens 1016 at the transition point between two events 726 should have attention weights 1154 the same or similar for the two events 726. For example, referring to the cross-attn map 932, the attention weights 1154 determined at the E1 938 and E2 936 boundary, which is also a scene cut 940, have a same attention weight 1154 before and after the E1 938 and E2 936 boundary.

The video block 916 and/or the video generation component may have additional components such as additional cross-attn components, MLPs, normalization components, fully connect neural network layers, scale and/or shift component, and so forth. Additionally, the video token 1016, video token with noise 1014, and/or rotated video token 1030 can be input to multiple components with operations such as addition performed with the output of other components and/or other inputs.

FIG. 11 illustrates the operation 1100 of training a video generation component, in accordance with some examples. The legend 1150 illustrates the attention weight 1154 for different patterns 1152. The operation 1100 of training a video generation component 702 illustrates training when timestamps are used as the rotation angle. The following describes how the attention weights 1154 are determined for operation 1100. The rotation component 1032 determines a rotation angle 1034 for the video tokens 1016, z, based on the time range 1017 or timestamp, t, of the video token 1016. Additionally, the text embs component 1036 determines the text embs 1038 for an event 726 based on the time range 1041, which is from the start time 728 to the end time 730, of the text embs component 1036. For example,

$${t}_{n}^{mid} = ( {t}_{n}^{end} - {t}_{n}^{start} ) / 2.$$

The training component 1002 can use Equation (5): \tilde{z}_{[t,⋅,⋅]}=R(z_{[t,⋅,⋅]}, t) to determine the rotation angle 1034 for the video tokens 1016, and text embs component 1036 can use

$${\tilde{e}}_{n}^{c} = R ( {e}_{n}^{c} , {t}_{n}^{mid} )$$

to d to determine the text embs 1038. The temporal cross-attn 922
component can use Equation (6):

$$Attn ( {\tilde{𝓏}}_{[ t , \cdot , \cdot ]} , {\tilde{e}}_{n}^{c} ) = Re [ R ( {𝓏}_{[ t , \cdot , \cdot ]} , {e}_{n}^{c} ) , t - {t}_{n}^{mid} ) ]$$

to determine the attention weights 1154.

Along the top of the cross-attn map 1147 are text embs 1110 and rotate timestamp 1108. The rotate timestamp 1108 is the midpoint of the time range of the E1 1126 and E2 1124, which is 4.0 1104 and 9.0 1106, respectively. Time 1120 progresses from the top to the bottom. T1 (MID) 1112 is the midpoint of E1 1126. T2 (MID) 1118 is the midpoint of E2 1124.

An issue that may affect the training and production performance of the video generation component 702 is that at a particular time 1120 during a time range 1041 of an event 726, a midpoint of the time range 1041 for a different event 726 may be closer to the particular time 1120 than the midpoint of the time range 1041 of the event 726.

For example, for video tokens 1122 at a time 1120 of “7”, T2 (mid) 1118 is two 1116 away from time 1120 of “7”, which is closer than T1 (mid) 1112, which is three 1114 away from time 1120 of “7”. This results in the attention weight 1154 for the video tokens 1122 at a time 1120 of “7” having a lower attention weight 1154 for E1 1126 than for E2 1124. This is illustrated at 1156 where the pattern 1152 is more filled in or darker for E1 1126 than E2 1124. This is not in accordance with the first property discussed above.

Additionally, at 1157, the attention weights 1154 are not the same for E1 1126 and E2 1124, which is not in accordance with third property discussed above and can make it difficult for the trained video generation component 702 to detect boundaries between events 726.

The operation 1102 of training a video generation component illustrates training when events are rescaled to all have a same length, L, and then the timestamps are determined in accordance with Equation (5) above. The examples described in conjunction with Equation (7) and Equation (8) are termed rescaled rotation.

A timestamp, t, within the n-th event, is transformed in accordance with Equation (7):

$$\tilde{t} = \frac{( t - {t}_{n}^{start} ) L}{{t}_{n}^{end} - {t}_{n}^{start}} + ( n - 1 ) L , where {t}_{n}^{start} \leq t \leq {t}_{n}^{end} .$$

The time is transformed for both video tokens 1146 and events 726 in accordance with Equation (8):

$$\tilde{t} - {\tilde{t}}_{n}^{mid} = ( \frac{t - {t}_{n}^{start}}{{t}_{n}^{end} - {t}_{n}^{start}} - \frac{1}{2} ) L .$$

The video tokens 1146 now attend to the events 726 more for events 726 during the time range 1041 of the video tokens 1146 compared to operation 1100. This is illustrated as the attention weights 1154 of the cross-attn map 1149. Along the top of the cross-attn map 1149 are text embs 1134 and rotate timestamp 1108. The attention weights 1154 above the rescaled time 1144 of “4”, which corresponds to the time range 1041 of E1 1151, for the column E1 are larger than or equal to the attention weights 1154 for the column under E2 above the rescaled time 1144 of “4”.

The rescaled time 1144 now has a T1 (MID) 1136 of “2” and a T2 (MID) 1142 of “6”. The video tokens 1146 at the rescaled time 1144 of “4” are now not closer to T2 (MID) 1142 than T1 (MID) 1136. The distance 1138 of “2” and distance 1140 of “2” are now the same distance. Additionally, at 1158 the attention weights 1154 are the same at the event boundary between E1 1151 and E2 1148. In some examples, L in Equation (8) is set to a fixed length, which rescales videos of the video tokens 1146 to have a same length.

Including scene cuts 908 of FIG. 9 expands the number of ground truth inputs 1008 that can be used because so many videos include scene cuts 908. Additionally, scene cuts 908 provide an important cinematographic effect. Scene cuts 908 are treated as a special event with the same content and equal start timestamps and end timestamps, termed the time 1011, referring to FIG. 10. The training component 1002 initializes a learning vector e^{cut}∈ [symbol] ^{1×D\hat{ }c}, the rescaled rotation example of the training component 1002 is used with the timestamp

$${t}_{n}^{cut}$$

transformed by Equation (7) and concatenated with the text embs 1038. The training component 1002 then performs cross-attention at the temporal cross-attn 922 module in accordance with Equation (9):

$${\tilde{e}}_{n}^{cut} = Re R ( {e}_{n}^{cut} , {t}_{n}^{cut} , {t}_{n}^{cut} ) , \\ and \tilde{𝓏} = XAttn ( 𝓏 , Concat ( [ {\tilde{e}}_{1}^{c} , ... , {\tilde{e}}_{N \hat{} e}^{c} , {\tilde{e}}_{1}^{cut} , ... , {\tilde{e}}_{N \hat{} cut}^{cut} ] ) ) .$$

During production use, zeros can be entered into the video generation component 702 for scene cuts 908 to prevent the video generation component 702 from generating scenes cuts 908. The training of the audio generation component 750 or sequence of data generation component 752 is the same or similar.

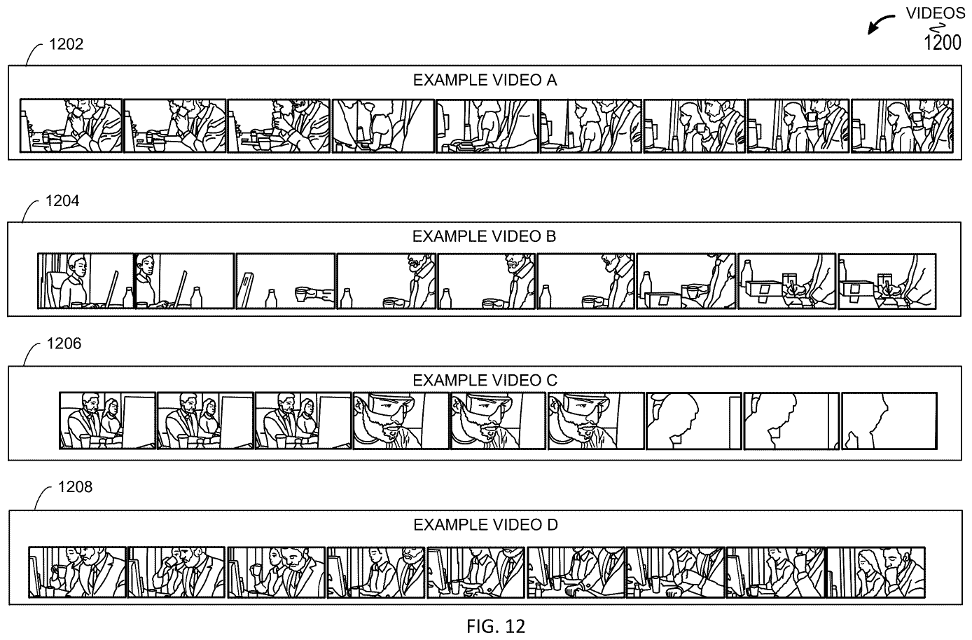

FIG. 12 illustrates example videos 1200, in accordance with some examples. The example videos 1200 were generated from different examples, referring to FIG. 7, of the video generation component 702. The text prompts 712 used were “A woman takes a sip from a cup and puts it down”, “A man is writing something on the paper”, and “They both start thinking with their left hand under their mouth.” In example video A 1202, the video generation component 702 was trained with concatenating all the text prompts 712 together. In example video A 1202, only the first event of “sipping coffee” is generated in the video 714 and the gender of the person sipping the coffee is incorrect.

In example video B 1204, the video generation component 702 was trained using autoregressive generation, where the video generation component 702 predicts the next video token based on the previous video token to generate the next portion of the video. Example video B 1204 stagnates and cannot generate the third event of “They both start thinking with their left hand under their mouth.”

In example video C 1206, the video generation component 702 was trained using multi-event video generation where the last frame of the previous video is fed into the video generation component 702 to generate the next portion of the video. Example video C 1206 changes the identify of the person and generates abrupt event transitions.

In example video D 1208, the video generation component 702 was trained in accordance with Equations (7)-(9) and re-rotate and time scale adjustment. Additionally, the text prompts 712 were processed by the text prompt enhancer 732 to generate start time 728 and end times 730 for each of the events 726, and a global caption 734 was generated. The example video D 1208 generates a video with all three events, “A woman takes a sip from a cup and puts it down”, “A man is writing something on the paper”, and “They both start thinking with their left hand under their mouth.” Additionally, example video D 1208 preserves the identity of the people illustrated and the video quality does not progressively deteriorate.

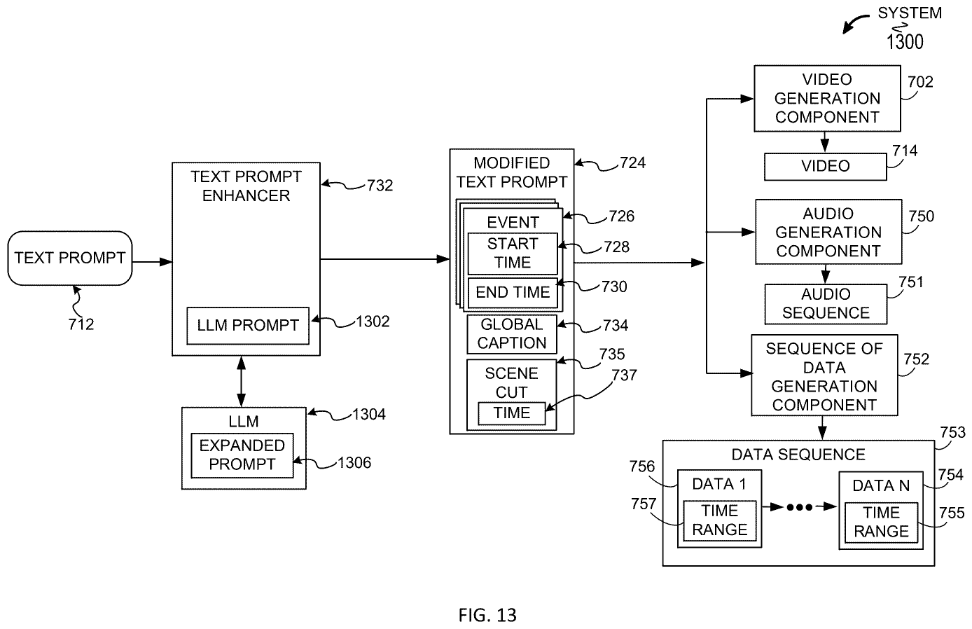

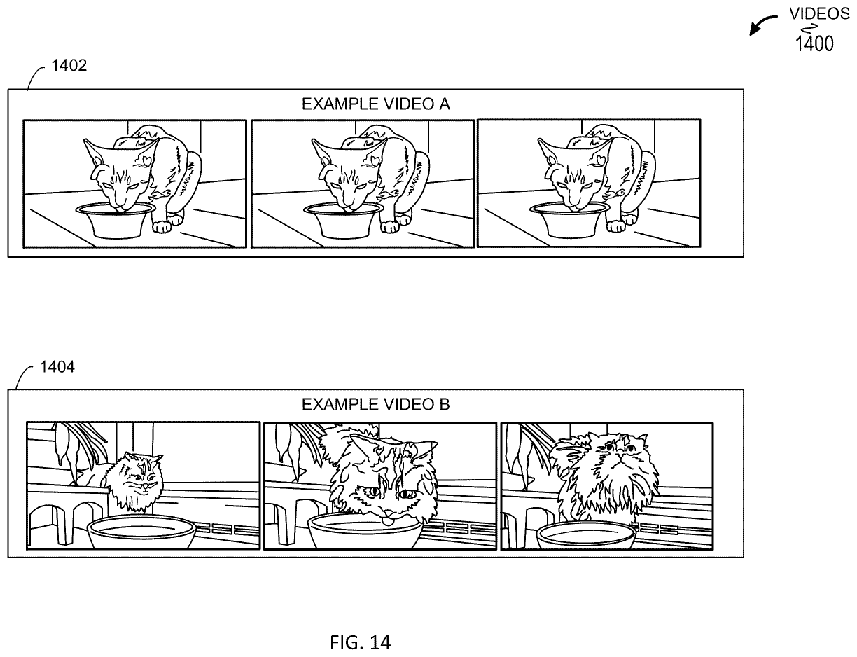

FIG. 13 illustrates a system 1300 for enhanced prompts, in accordance with some examples. FIG. 14 illustrates example videos 1400, in accordance with some examples. FIGS. 13 and 14 are disclosed in conjunction with one another. The text prompt enhancer 732 receives or accesses a text prompt 712. For example, the text prompt 712 can be “a cat drinking water.” Example video A 1402 is a video 714 generated by the video generation component 702 with a text prompt 712 of “a cat is drinking water.”

The text prompt enhancer 732 generates a large language model (LLM) prompt (LLM prompt 1302). The text prompt enhancer 732 may generate a LLM prompt 1302 such as “expand ‘a cat drinking water’ into individual steps with a start time and an end time for each step.” The LLM prompt 1302 is then entered into a LLM 1304, which generates an expanded prompt 1306 such as “a cat looks at a water dish (start: 0:0, end: 0:03),” “the cat walks to the water dish and drinks the water (start: 0:03, end: 0:09),” and “the cat looks satiated (start: 0:09, end: 0:11).” The text prompt enhancer 732 can format the expanded prompt 1306 into the modified text prompt 724 format, and then sends it or makes it available to the video generation component 702. The video generation component 702 generates the video 714 based on the modified text prompt 724. Example video B 1404 is an example of a video 714 generated using the expanded prompt 1306. The text prompt enhancer 732 can expand the text prompt 712 in other ways such as having its own trained neural networks to break down a single prompt into steps. Additionally, the expanded prompt 1306 may include the global caption 734 and scene cuts 735. The text prompt enhancer 732 can separate the operations or functions between the LLM 1304 component or another component. For example, the LLM 1304 component can split the text prompt 712 into steps and the text prompt enhancer 732 can format the expanded prompt 1306 into a format such as the modified text prompt 724 and add a global caption 734 and one or more scene cuts 735.

The audio generation component 750 or sequence of data generation component 752 take a text prompt 712 and generates a an audio sequence 751 or data sequence 753 based on the text prompt 712. The video controls 716 provide operations for editing or playing the audio sequence 751 or data sequence 753. The audio generation component 750 or sequence of data generation component 752 are temporally-controlled multi-event audio sequence or data sequence generation components, in accordance with some examples. The audio generation component 750 or sequence of data generation component 752 reside on the user system 102, the server system 110, and/or one or more other computing devices. The functionality of the audio generation component 750 or sequence of data generation component 752 may be split among multiple computing devices such as between the data sequence generation system 234 of FIG. 2 and audio generation component 750 or sequence of data generation component 752.

The data sequence 753 may be composed of data 1 756 through data n 754 where each data 1 756 and data N 754 includes a time range 757, 755, respectively. The data may be data such as stock market data or other data that may be processed by the training component 1002. The data can be financial data of a company with text descriptions such as “running a deficit”, “in the black,” “high growth,” and so forth. The data may be data relating to the health of a person with descriptions such “ill,” “losing weight,” “high heart rates,” “poor sleep,” and so forth. One skilled in the art will recognize that other types of data that have text descriptions can be used to training the sequence of data generation component 752.

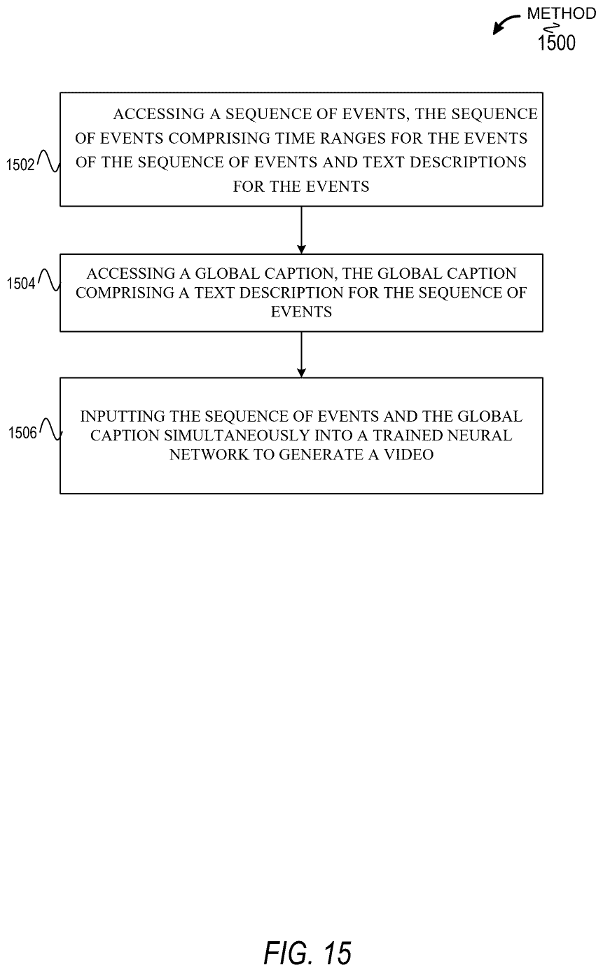

FIG. 15 illustrates a method 1500 for temporally-controlled multi-event video generation, in accordance with some embodiments. The method 1500 begins at operation 1502 with accessing a sequence of events, the sequence of events comprising time ranges for the events of the sequence of events and text descriptions for the events. For example, the modified text prompt 724 includes a sequence of events 726 including time ranges, start time 728 through end time 730, for each of the events with text descriptions for each event 726.

The method 1500 continues at operation 1504 with accessing a global caption, the global caption comprising a text description for the sequence of events. For example, the modified text prompt 724 includes a global caption 734.

The method 1500 continues at operation 1506 with inputting the sequence of events and the global caption simultaneously into a trained neural network to generate a video. For example, the modified text prompt 724 is input into the video generation component 702 to generate the video 714 where the video 714 includes portions that correspond to the events 726. The method 1500 is a computer-implemented method. In some examples, operation 1506 includes wherein content depicted within frames of the video during a time range of the time ranges is in accordance with a corresponding text description of the text descriptions.

The method 1500 optionally includes one or more additional operations, the operations of method 1500 can be performed in a different order, or one or more of the operations of the method 1500 can be optional. The method 1500 may be performed in whole or in part by one or more computing devices, or an apparatus of one or more computing devices disclosed herein. The functions of a component, such as the video generation component 702, are performed or executed by one or more computing devices configured to perform or execute the functions of the component.

### EXAMPLE STATEMENTS

Example 1 is a system comprising: at least one processor; at least one memory component storing instructions that, when executed by the at least one processor, cause the at least one processor to perform operations comprising: accessing a sequence of events, the sequence of events comprising time ranges for events of the sequence of events and text descriptions for the events; accessing a global caption, the global caption comprising a text description for the sequence of events; and inputting the sequence of events and the global caption simultaneously into a trained neural network to generate a video or an audio sequence.

In Example 2, the subject matter of Example 1 includes, wherein content depicted within frames of the video or sounds of the audio sequence during a time range of the time ranges is in accordance with a corresponding text description of the text descriptions.

In Example 3, the subject matter of Examples 1-2 includes, wherein the operations further comprise: accessing a text prompt, the text prompt comprising a plurality of portions; generating an event for each of the plurality of portions to generate the sequence of events; determining the time ranges for the sequence of events; and determining the global caption based on the sequence of events.

In Example 4, the subject matter of Example 3 includes, wherein the trained neural network is a first trained neural network, and wherein the generating the event for each of the plurality of portions to generate the sequence of events further comprises: invoking a second trained neural network with the text prompt as input and a request indicating the second trained neural network is to generate an event for each of the plurality of portions.

In Example 5, the subject matter of Examples 1~4 includes, wherein content depicted in frames of the video or sounds of the audio sequence are in accordance with the text description of the global caption.

In Example 6, the subject matter of Examples 1-5 includes, wherein the operations further comprise: accessing a text prompt, the text prompt comprising a text description of an event; and generating the sequence of events from the text description.

In Example 7, the subject matter of Example 6 includes, wherein the trained neural network is a first trained neural network, and wherein the generating the sequence of events from the text description further comprises: invoking a second trained neural network with the text description as input and a request indicating the second trained neural network is to generate the sequence of events and the time ranges.

In Example 8, the subject matter of Examples 1-7 includes, wherein the sequence of events comprises a scene cut, the scene cut comprising a scene cut time, wherein content depicted in frames of the video or sounds of the audio sequence before the scene cut time are not continuous with content depicted in the frames of the video or the sounds of the audio sequence after the scene cut time.

In Example 9, the subject matter of Examples 1-8 includes, wherein the inputting further comprising: encoding the global caption; inputting the encoded global caption into a global cross-attention component of the trained neural network; encoding the sequence of events in accordance with the time ranges for the events of the sequence of events; concatenating the encoded sequence of events to generate a concatenated encoded sequence of events; and inputting the concatenated encoded sequence of events into a temporal cross-attention component of the trained neural network.

In Example 10, the subject matter of Example 9 includes, wherein the time ranges for the sequence of events are rescaled to have a same length and the encoding is based on midpoint times of the time ranges.

In Example 11, the subject matter of Examples 9-10 includes, wherein the sequence of events comprises a scene cut, the scene cut comprising a scene cut time, and wherein the inputting the sequence of events and the global caption simultaneously further comprise: encoding the scene cut time in accordance with a rescaled time of the scene cut; and concatenating the scene cut time with the concatenated encoded sequence of events.

In Example 12, the subject matter of Examples 1-11 includes, wherein the trained neural network is trained based on inputting a concatenated encoded sequence of events and video tokens rotated based on a timestamp of the video token into a temporal cross-attention component of the trained neural network, wherein the time ranges for the sequence of events are rescaled to have a same length and the encoding is based on midpoint times of the time ranges.

In Example 13, the subject matter of Examples 1-12 includes, wherein the trained neural network is trained based on inputting a concatenated encoded sequence of events and video tokens are positionally embedded based on a timestamp of the video token into a temporal cross-attention component of the trained neural network, wherein the time ranges for the sequence of events are rescaled to have a same length and the encoding is based on midpoint times of the time ranges.

Example 14 is a computer-implemented method comprising: accessing a sequence of events, the sequence of events comprising time ranges for events of the sequence of events and text descriptions for the events; accessing a global caption, the global caption comprising a text description for the sequence of events; and inputting the sequence of events and the global caption simultaneously into a trained neural network to generate a video, audio sequence, or data sequence, wherein content depicted within frames of the video, sounds of the audio sequence, or data of the data sequence during a time range of the time ranges is in accordance with a corresponding text description of the text descriptions.

In Example 15, the subject matter of Example 14 includes, wherein content depicted within frames of the video, sounds of the audio sequence, or data of the data sequence during a time range of the time ranges is in accordance with a corresponding text description of the text descriptions.

Example 16 is a non-transitory computer-readable storage medium storing instructions that, when executed by at least one processor, cause the at least one processor to perform operations comprising: accessing a sequence of events, the sequence of events comprising time ranges for events of the sequence of events and text descriptions for the events; accessing a global caption, the global caption comprising a text description for the sequence of events; and inputting the sequence of events and the global caption simultaneously into a trained neural network to generate a video or an audio sequence.

In Example 17, the subject matter of Example 16 includes, wherein content depicted within frames of the video or sounds of the audio sequence during a time range of the time ranges is in accordance with a corresponding text description of the text descriptions.

In Example 18, the subject matter of Examples 16-17 includes, wherein frames of the video or sounds of the audio sequence are in accordance with the text description of the global caption.

In Example 19, the subject matter of Examples 16-18 includes, wherein the operations further comprise: accessing a text prompt, the text prompt comprising a plurality of portions; generating an event for each of the plurality of portions to generate the sequence of events; determining the time ranges for the sequence of events; and determining the global caption based on the sequence of events.

In Example 20, the subject matter of Examples 16-19 includes, wherein the inputting further comprising: encoding the global caption; inputting the encoded global caption into a global cross-attention component of the trained neural network; encoding the sequence of events in accordance with the time ranges for the events of the sequence of events; concatenating the encoded sequence of events to generate a concatenated encoded sequence of events; and inputting the concatenated encoded sequence of events into a temporal cross-attention component of the trained neural network.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing a sequence of events, the sequence of events comprising time ranges for events of the sequence of events and text descriptions for the events;
accessing a global caption, the global caption comprising a text description for the sequence of events; and
inputting the sequence of events and the global caption simultaneously into a trained neural network to generate a video or an audio sequence.

2. The system of claim 1, wherein content depicted within frames of the video or sounds of the audio sequence during a time range of the time ranges is in accordance with a corresponding text description of the text descriptions.

3. The system of claim 1, wherein the operations further comprise:
accessing a text prompt, the text prompt comprising a plurality of portions;
generating an event for each of the plurality of portions to generate the sequence of events;
determining the time ranges for the sequence of events; and
determining the global caption based on the sequence of events.

4. The system of claim 3, wherein the trained neural network is a first trained neural network, and wherein the generating the event for each of the plurality of portions to generate the sequence of events further comprises:
invoking a second trained neural network with the text prompt as input and a request indicating the second trained neural network is to generate an event for each of the plurality of portions.

5. The system of claim 1, wherein content depicted in frames of the video or sounds of the audio sequence are in accordance with the text description of the global caption.

6. The system of claim 1, wherein the operations further comprise:
accessing a text prompt, the text prompt comprising a text description of an event; and
generating the sequence of events from the text description.

7. The system of claim 6, wherein the trained neural network is a first trained neural network, and wherein the generating the sequence of events from the text description further comprises:
invoking a second trained neural network with the text description as input and a request indicating the second trained neural network is to generate the sequence of events and the time ranges.

8. The system of claim 1, wherein the sequence of events comprises a scene cut, the scene cut comprising a scene cut time, wherein content depicted in frames of the video or sounds of the audio sequence before the scene cut time are not continuous with content depicted in the frames of the video or the sounds of the audio sequence after the scene cut time.

9. The system of claim 1, wherein the inputting further comprising:
encoding the global caption;
inputting the encoded global caption into a global cross-attention component of the trained neural network;
encoding the sequence of events in accordance with the time ranges for the events of the sequence of events;
concatenating the encoded sequence of events to generate a concatenated encoded sequence of events; and
inputting the concatenated encoded sequence of events into a temporal cross-attention component of the trained neural network.

10. The system of claim 9, wherein the time ranges for the sequence of events are rescaled to have a same length and the encoding is based on midpoint times of the time ranges.

11. The system of claim 9, wherein the sequence of events comprises a scene cut, the scene cut comprising a scene cut time, and wherein the inputting the sequence of events and the global caption simultaneously further comprise:
encoding the scene cut time in accordance with a rescaled time of the scene cut; and
concatenating the scene cut time with the concatenated encoded sequence of events.

12. The system of claim 1, wherein the trained neural network is trained based on inputting a concatenated encoded sequence of events and video tokens rotated based on a timestamp of the video token into a temporal cross-attention component of the trained neural network, wherein the time ranges for the sequence of events are rescaled to have a same length and the encoding is based on midpoint times of the time ranges.

13. The system of claim 1, wherein the trained neural network is trained based on inputting a concatenated encoded sequence of events and video tokens are positionally embedded based on a timestamp of the video token into a temporal cross-attention component of the trained neural network, wherein the time ranges for the sequence of events are rescaled to have a same length and the encoding is based on midpoint times of the time ranges.

14. A computer-implemented method comprising:
accessing a sequence of events, the sequence of events comprising time ranges for events of the sequence of events and text descriptions for the events;
accessing a global caption, the global caption comprising a text description for the sequence of events; and
inputting the sequence of events and the global caption simultaneously into a trained neural network to generate a video, audio sequence, or data sequence, wherein content depicted within frames of the video, sounds of the audio sequence, or data of the data sequence during a time range of the time ranges is in accordance with a corresponding text description of the text descriptions.

15. The computer-implemented method of claim 14, wherein content depicted within frames of the video, sounds of the audio sequence, or data of the data sequence during a time range of the time ranges is in accordance with a corresponding text description of the text descriptions.

16. A non-transitory computer-readable storage medium storing instructions that, when executed by at least one processor, cause the at least one processor to perform operations comprising:
accessing a sequence of events, the sequence of events comprising time ranges for events of the sequence of events and text descriptions for the events;
accessing a global caption, the global caption comprising a text description for the sequence of events; and
inputting the sequence of events and the global caption simultaneously into a trained neural network to generate a video or an audio sequence.

17. The non-transitory computer-readable storage medium of claim 16, wherein content depicted within frames of the video or sounds of the audio sequence during a time range of the time ranges is in accordance with a corresponding text description of the text descriptions.

18. The non-transitory computer-readable storage medium of claim 16, wherein frames of the video or sounds of the audio sequence are in accordance with the text description of the global caption.

19. The non-transitory computer-readable storage medium of claim 16, wherein the operations further comprise:
accessing a text prompt, the text prompt comprising a plurality of portions;
generating an event for each of the plurality of portions to generate the sequence of events;
determining the time ranges for the sequence of events; and
determining the global caption based on the sequence of events.

20. The non-transitory computer-readable storage medium of claim 16, wherein the inputting further comprising:
encoding the global caption;
inputting the encoded global caption into a global cross-attention component of the trained neural network;
encoding the sequence of events in accordance with the time ranges for the events of the sequence of events;
concatenating the encoded sequence of events to generate a concatenated encoded sequence of events; and
inputting the concatenated encoded sequence of events into a temporal cross-attention component of the trained neural network.
